(19) United States
(12) Patent Application Publication
(10) Pub. No.: US 2020/0114469 A1
(43) Pub. Date: Apr. 16, 2020

(54) METHOD FOR LASER WELDING LIGHT METAL WORKPIECES THAT INCLUDE A SURFACE OXIDE COATING

(71) Applicant: GM GLOBAL TECHNOLOGY OPERATIONS LLC, Detroit, MI (US)

(72) Inventors: Wu Tao, Tianmen (CN); David Yang, Shanghai (CN); Yu Pan, Beijing (CN)

(21) Appl. No.: 16/484,008

(22) PCT Filed: Feb. 9, 2017
(86) PCT No.: PCT/CN2017/000147

§ 371 Date: Aug. 6, 2019

(51) Int. Cl. B23K 26/32; B23K 26/244; B23K 26/082

(52) U.S. Cl. CPC B23K 26/32; B23K 2103/10; B23K 26/082; B23K 26/244

(57) ABSTRACT

A method of laser welding together two or more overlapping light metal workpieces (12, 14, or 12, 150, 14) involves advancing a laser beam (24) relative to the top surface (20) of the workpiece stack-up (10) multiple times along a closed-curve weld path (72). The conductive heat transfer associated with such advancement of the laser beam (24) grows and develops a larger melt puddle (76) that penetrates into the workpiece stack-up (10) and intersects each faying interface (34 or 160, 162) established within the stack-up (10). Upon halting transmission of the laser beam (24) or otherwise removing the laser beam (24) from the closed-curved weld path (72), the melt puddle (76) solidifies into a laser weld joint (66) comprised of resolidified composite workpiece material (78).

### TECHNICAL FIELD

The technical field of this disclosure relates generally to a method for laser welding together light metal workpieces that include a surface oxide coating such, for example, aluminum workpieces and magnesium workpieces.

### BACKGROUND

Laser welding is a metal joining process in which a laser beam is directed at an assembly of stacked-up metal workpieces to provide a concentrated heat source capable of effectuating a weld joint between the constituent metal workpieces. In general, complimentary flanges or other bonding regions of two or more metal workpieces are first aligned, fitted, and stacked relative to one another such that their faying surfaces overlap and confront to establish one or more faying interfaces. A laser beam is then directed at an accessible top surface of the workpiece stack-up within a welding region spanned by the overlapping portion of the workpieces. The heat generated from the absorption of energy from the laser beam initiates melting of the metal workpieces and establishes a molten metal weld pool within the workpiece stack-up. The molten metal weld pool penetrates into the stack-up and intersects at least one, and usually all, of the established faying interfaces. And, if the power density of the laser beam is high enough, a keyhole is produced beneath a beam spot of the laser beam within the molten metal weld pool. A keyhole is a column of vaporized metal, which may include plasma, derived from the metal workpieces. The keyhole is an effective absorber of energy from the laser beam, thus allowing for deep and narrow penetration of molten workpiece metal into the stack-up.

The molten metal weld pool and, if present, the keyhole, are created in very short order once the laser beam impinges the top surface of the workpiece stack-up. After the metal workpieces are initially melted, the beam spot of the laser beam may be advanced relative to the top surface of the workpiece stack-up, which has conventionally involved moving the laser beam along a beam travel pattern of a relatively simple or complex geometrical profile as projected onto the top surface of the stack-up. As the laser beam is advanced along the top surface of the stack-up, molten workpiece metal from the weld pool flows around and behind the advancing beam spot within the workpiece stack-up. This penetrating molten workpiece metal quickly cools and solidifies in the wake of the advancing laser beam into resolidified metal workpiece material. The transmission of the laser beam at the top surface of the workpiece stack-up is eventually ceased once the laser beam has finished tracking the beam travel pattern, at which time the keyhole collapses, if present, and any molten workpiece metal still remaining within the stack-up solidifies. The collective resolidified composite workpiece material obtained by operation of the laser beam constitutes a laser weld joint that autogenously fusion welds the overlapping metal workpieces together.

Many industries use laser welding as part of their manufacturing practice including the automotive, aviation, maritime, railway, and building construction industries, among others. Laser welding is an attractive joining process because it requires only single side access, can be practiced with reduced flange widths, and results in a relatively small heat-affected zone within the stack-up assembly that minimizes thermal distortion in the metal workpieces. In the automotive industry, for example, laser welding can be used to join together metal workpieces during the manufacture of the body-in-white (BIW) as well as finished hang-on parts that are installed on the BIW prior to painting. Some specific instances where laser welding may be used include the construction and attachment of load-bearing body structures within the BIW such as rail structures, rockers, A-, B-, and C-pillars, and underbody cross-members. Other specific instances where laser welding may also be used include non-load-bearing attachments within the BIW, such as the attachment of a roof to a side panel, and to join overlying flanges encountered in the construction of the doors, hood, and trunk.

The practice of laser welding can present challenges for certain types of metal workpieces. For example, when the metal workpieces included in the workpiece stack-up are light weight metal workpieces that include a surface oxide coating, which is typically the case for aluminum workpieces and magnesium workpieces, there is a possibility that weld performance may suffer. To be sure, the surface oxide coating found on aluminum and magnesium workpieces is typically a native refractory oxide coating that is thermally and electrically insulating as well as mechanically tough. Because the surface oxide coating is difficult to break down and is a poor conductor of heat, it can suppress the rate of heat transfer into the underlying bulk aluminum or magnesium, at least at the outset of the laser welding process. Additionally, the surface oxide coating and moisture from the immediate surrounding vicinity may be a source of hydrogen when the surface oxide coating is heated by the laser beam to elevated temperatures. Hydrogen has a relatively high solubility in both molten aluminum and molten magnesium. To that end, the localized generation of hydrogen in close proximity to molten workpiece material, and the presence of oxide coating fragments themselves in the molten workpiece material, can lead to porosity within the final solidified laser weld joint.

### SUMMARY OF THE DISCLOSURE

An embodiment of a method of laser welding together two or more light metal workpieces may include several steps. First, a laser beam is directed at a top surface a workpiece stack-up that comprises two or more overlapping light metal workpieces. The workpiece stack-up, more specifically, includes at least a first light metal workpiece and a second light metal workpiece that overlap within a welding region. The first light metal workpiece provides the top surface of the workpiece stack-up and the second light metal workpiece provides a bottom surface of the workpiece stack-up, and each pair of adjacent overlapping light metal workpieces within the workpiece stack-up establishes a faying interface therebetween. Second, a beam spot of the laser beam is advanced relative to the top surface of the workpiece stack-up such that the beam spot is advanced multiple times along a closed-curved weld path at a beam travel speed of 8 m/min or greater. Such advancement of the beam spot of the laser beam grows and develops a melt puddle that extends inwards and downwards from the closed-curved weld path on the top surface of the workpiece stack-up. The melt puddle penetrates the workpiece stack-up from the top surface towards the bottom surface and intersects each faying interface established within the welding region of the workpiece stack-up. Third, the melt puddle is allowed to solidify in to a laser weld joint comprised of resolidified composite workpiece material. The laser weld joint fusion welds the two or more overlapping light metal workpieces together within the welding region.

In certain practices of the disclosed laser welding method, the workpiece stack-up may include two overlapping light metal workpieces or it may include three overlapping light metal workpieces. For example, in a two workpiece stack-up, the first light metal workpiece has an exterior outer surface and a first faying surface, and the second light metal workpiece has an exterior outer surface and a second faying surface. The exterior outer surface of the first light metal workpiece provides the top surface of the workpiece stack-up and the exterior outer surface of the second light metal workpiece provides the bottom surface of the workpiece stack-up. And, consequently, the first and second faying surfaces of the first and second light metal workpieces overlap and confront to establish a faying interface.

As another example, in a three workpiece stack-up, the first light metal workpiece has an exterior outer surface and a first faying surface, and the second light metal workpiece has an exterior outer surface and a second faying surface. The exterior outer surface of the first light metal workpiece provides the top surface of the workpiece stack-up and the exterior outer surface of the second light metal workpiece provides the bottom surface of the workpiece stack-up. Additionally, the workpiece stack-up further includes a third light metal workpiece situated between the first and second light metal workpieces. The third light metal workpiece has opposed third and fourth faying surfaces. To that end, the third faying surface overlaps and confronts the first faying surface of the first light metal workpiece to establish a first faying interface, and the fourth faying surface overlaps and confronts the second faying surface of the second light metal workpiece to establish a second faying interface.

The aforementioned embodiment of the method of laser together light metal workpieces may be further defined. To be sure, each of the two or more overlapping light metal workpieces may be an aluminum workpiece or a magnesium workpiece. Furthermore, the closed-curved weld path may be a circle weld path that has a diameter ranging, for example, from 4 mm to 12 mm Still further, the beam spot of the laser beam may be advanced completely along the closed-curve weld path—whether the closed-curved weld path is a circle weld path, an elliptical weld path, or some other weld path—anywhere from four times to eighty times. And, in so doing, the laser beam may be advanced along the closed-curved weld path at a beam travel speed that ranges from 8 m/min to 120 m/min. The laser beam that is directed towards the top surface of the workpiece stack-up and advanced along the closed-curved weld path may be a solid-state laser beam whose movement is controlled and performed by a remote laser welding apparatus.

In some instances of practicing aforementioned embodiment of the method of laser together light metal workpieces, particularly when the the closed-curve weld path is a certain size or larger, a central notch may materialize in the laser weld joint that extends downwards from a top surface of the joint. This may occur as a result of the stirring effect induced by repeatedly advancing the beam spot of the laser beam along the closed-curved weld path and the rapid solidification of the melt puddle that ensues. In order to consume and eliminate a central notch of this type, the embodiment of the laser welding method may further, and optionally, call for retransmitting the laser beam and advancing the beam spot of the laser beam relative to the top surface of the laser weld joint along a secondary beam travel pattern contained within the closed-curved weld path. The advancement of the laser beam along the secondary beam travel pattern causes a portion of the laser weld joint to remelt and to thus fill in and consume the previously-defined central notch. In one particular implementation, the secondary beam travel pattern may be a second closed-curve weld path, and the beam spot of the laser beam may be advanced multiple times along the second closed-curved weld path at a beam travel speed of 8 m/min or greater. The second closed-curved weld path may, for example, be a second circle weld path having a diameter that ranges from 0.5 mm to 6.0 mm.

Another embodiment of a method of a method of laser welding together two or more light metal workpieces may include several steps. First, a workpiece stack-up is provided that includes two or more light metal workpieces that overlap to define a welding region. The welding region of the workpiece stack-up has a top surface and a bottom surface and further establishes a faying interface between each pair of adjacent light metal workpieces included in the workpiece stack-up. All of the two or more light metal workpieces in the workpiece stack-up are either aluminum or magnesium workpieces. Second, a laser beam is directed at the top surface of the workpiece stack-up to create a keyhole and a molten metal weld pool that surrounds the keyhole. Each of the keyhole and the surrounding molten metal weld pool penetrate into the workpiece stack-up from the top surface towards the bottom surface of the stack-up. Third, a beam spot of the laser beam is advanced relative to the top surface of the workpiece stack-up such that the beam spot is advanced multiple times along a closed-curved weld path at at beam travel speed of 8 m/min or greater to grow and develop a melt puddle that extends inwards and downwards from the closed-curved weld path. The melt puddle penetrates the workpiece stack-up from the top surface towards the bottom surface and intersects each faying interface established within the welding region of the stack-up. Fourth, the transmission of the laser beam is halted to allow the melt puddle to solidify into a laser weld joint comprised of resolidified composite workpiece material. The laser weld joint fusion welds the two or more overlapping light metal workpieces together within the welding region and further defines a central notch that extends downward into the weld joint from a top surface of the joint. Fifth, the laser beam is retransmitted and its beam spot is advanced relative to the top surface of the laser weld joint along a secondary beam travel pattern contained within the closed-curve weld path. The advancement of the laser beam along the secondary beam travel pattern melts a portion of the laser weld joint and consumes the central notch.

The aforementioned embodiment of the method of laser together light metal workpieces may be further defined. For instance, the workpiece stack-up may include two or three overlapping light metal workpieces. Additionally, the closed-curved weld path may be a circle weld path having a diameter that ranges from 4 mm to 12 mm. When that is the case, the aforementioned embodiment of the method of laser together light metal workpieces may employ a second circle weld path as the secondary beam travel patter. The second circle weld path may have a diameter that ranges from 0.5 mm to 6 mm and the laser beam may be advanced multiple times along the second circle path in order to melt a portion of the laser weld joint and consumes the central notch.

Still another embodiment of a method of laser welding together two or three light metal workpieces may include several steps. First, a workpiece stack-up is provided that includes two or three light metal workpieces that overlap to define a welding region. The welding region of the workpiece stack-up has a top surface and a bottom surface and further establishes a faying interface between each pair of adjacent light metal workpieces included in the workpiece stack-up. All of the two or more light metal workpieces in the workpiece stack-up are either aluminum or magnesium workpieces. Second, a laser weld joint is formed that fusion welds the two or three overlapping light metal workpieces together. The formation of the laser weld joint comprises operating a scanning optic laser head of a remote laser welding apparatus to direct a laser beam at the top surface of the workpiece stack-up and, additionally, to advance a beam spot of the laser beam relative to the top surface of the workpiece stack-up such that the beam spot is advanced multiple times along a closed-curved weld path at a beam travel speed of that ranges from 8 m/min to 120 m/min. Such advancement of the beam spot of the laser beam grows and develops a melt puddle that extends inwards and downwards from the closed-curved weld path on the top surface of the workpiece stack-up.

The aforementioned embodiment of the method of laser together light metal workpieces may be further defined. Indeed, the closed-curved weld path may be a circle weld path having a diameter that ranges from 4 mm to 12 mm, and the beam spot of the laser beam may be advanced completely along the circle weld path anywhere from four times to eighty times. Furthermore, in some implementations, the beam spot of the laser beam may also be advanced relative to the top surface of the laser weld joint along a secondary beam travel pattern contained within the closed-curved weld path so as to melt a portion of the laser weld joint and to consume and eliminate a central notch defined within the weld joint. The secondary beam travel pattern may be comprised of one or more weld paths that define an area that is 50% or less than an area defined by the closed-curved weld path on the top surface of the workpiece stack-up.

### BRIEF DESCRIPTION OF THE DRAWINGS

FIG. 1 is a general illustration of a workpiece stack-up that includes two overlapping light metal workpieces along with a remote laser welding apparatus that can carry out the disclosed laser welding method;

FIG. 1A is a magnified view of the laser beam depicted in FIG. 1 showing a focal point and a longitudinal axis of the laser beam;

FIG. 2 is a plan view of a top surface of the workpiece stack-up and a laser beam depicted in FIG. 1 as well several closed-curved weld paths as projected onto the top surface of the workpiece stack-up according to one embodiment of the present disclosure, and wherein the laser beam is repeatedly advanced along at least the largest and outermost closed-curved weld path during the formation of a laser weld joint that fusion welds together the overlapping light metal workpieces within the workpiece stack-up;

FIG. 3 is a cross-sectional view of the workpiece stack-up depicted in FIG. 2, taken along section lines 3-3, showing a molten metal weld pool and a keyhole, which are created by the laser beam, and wherein the molten metal weld pool and the keyhole penetrate into the workpiece stack-up from the top surface towards a bottom surface;

FIG. 4 is a plan view of the top surface of the workpiece stack-up melt depicting a larger melt puddle formed inward and downward from the closed-curved weld path as a result of heat conduction associated with advancing the laser beam multiple times along the closed-curved weld path;

FIG. 5 is a cross-sectional view of the workpiece stack-up depicted in FIG. 4, taken along the lines 5-5, showing the melt puddle, wherein the melt puddle penetrates into the workpiece stack-up from the top surface towards the bottom surface;

FIG. 6 is a cross-sectional view of the workpiece stack-up and a laser weld joint, which has been formed by repeatedly advancing the laser beam along the closed-curved weld path corresponding essentially to the circumference of the laser weld joint being formed, as illustrated in FIGS. 2-5, and wherein the laser weld joint fusion welds the two overlapping light metal workpieces together;

FIG. 7 is a cross-sectional view of the workpiece stack-up and a laser weld joint, which has been formed by repeatedly advancing the laser beam along the closed-curved weld path corresponding essentially to the circumference of the laser weld joint being formed, as illustrated in FIGS. 2-5, and wherein the laser weld joint fusion welds the two overlapping light metal workpieces together and further includes a central notch that extends downwards from a top surface of the laser weld joint;

FIG. 8 is a cross-sectional view of the workpiece stack-up taken from the same vantage as FIG. 3 and showing a molten metal weld pool and a keyhole, which are created by the laser beam, and wherein the molten metal weld pool and the keyhole penetrate into the workpiece stack-up from the top surface towards a bottom surface, although here the workpiece stack-up includes three overlapping light metal workpieces instead of two as depicted in FIG. 3; and

FIG. 9 is a cross-sectional view of the workpiece stack-up and a laser weld joint, which has been formed by repeatedly advancing the laser beam along the closed-curved weld path, as illustrated in FIGS. 2 and 8, and wherein the laser weld joint fusion welds the three overlapping light metal workpieces together.

### DETAILED DESCRIPTION

The disclosed method of laser welding two or more stacked-up light metal workpieces involves advancing a laser beam—and, in particular, the beam spot of the laser beam—relative to a top surface of the workpiece stack-up multiple times along a closed-curved weld path until a melt pool with satisfactory penetration has been developed that later solidifies into a laser weld joint. The closed-curved weld path that is traced by the laser beam may be circular weld path that has a constant diameter about its circumference, or it may be an elliptical weld path that has a major diameter that extends between the two farthest points on its circumference and and a minor diameter that extends between the two closest points on its circumference. The area defined by the closed-curved weld path corresponds for the most part to the area of the resultant laser weld joint. The laser beam may be advanced along the closed-curved path numerous times at a relatively fast travel speed of at least 8 m/min and, more specifically, between 8 m/min and 120 m/min By carrying out laser welding method in this way, a more efficient heat transfer rate can be realized between the laser beam and the workpiece stack-up and the resultant laser weld joint is more likely to possess minimal, if any, porosity.

The repeated tracing of the closed-curved weld path as needed to form the laser weld joint may be performed by a remote laser welding apparatus or a conventional laser welding apparatus such as, for example, an apparatus in which a fixed laser head is carried by a high-speed CNC machine. The laser beam employed to form the laser weld joint may be a solid-state laser beam or a gas laser beam depending on the characteristics of the light metal workpieces being joined and the laser welding mode (conduction, keyhole, etc.) desired to be practiced. Some notable solid-state lasers that may be used are a fiber laser, a disk laser, a direct diode laser, and a Nd:YAG laser, and a notable gas laser that may be used is a CO₂ laser, although other types of lasers may certainly be used. In a preferred implementation of the disclosed method, which is described below in more detail, a remote laser welding apparatus that includes a a scanning optic laser head having tiltable mirrors and a z-axis focal lens is employed to conduct the disclosed laser welding method, although other types of laser welding apparatuses that have comparable functionalities to a remote laser welding apparatus may certainly be used.

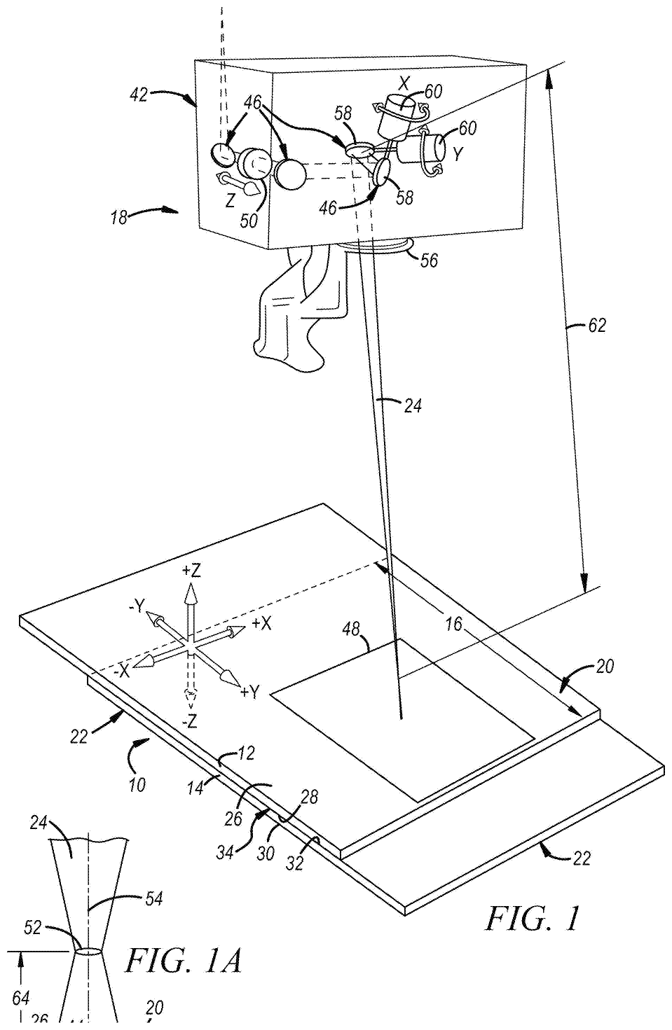

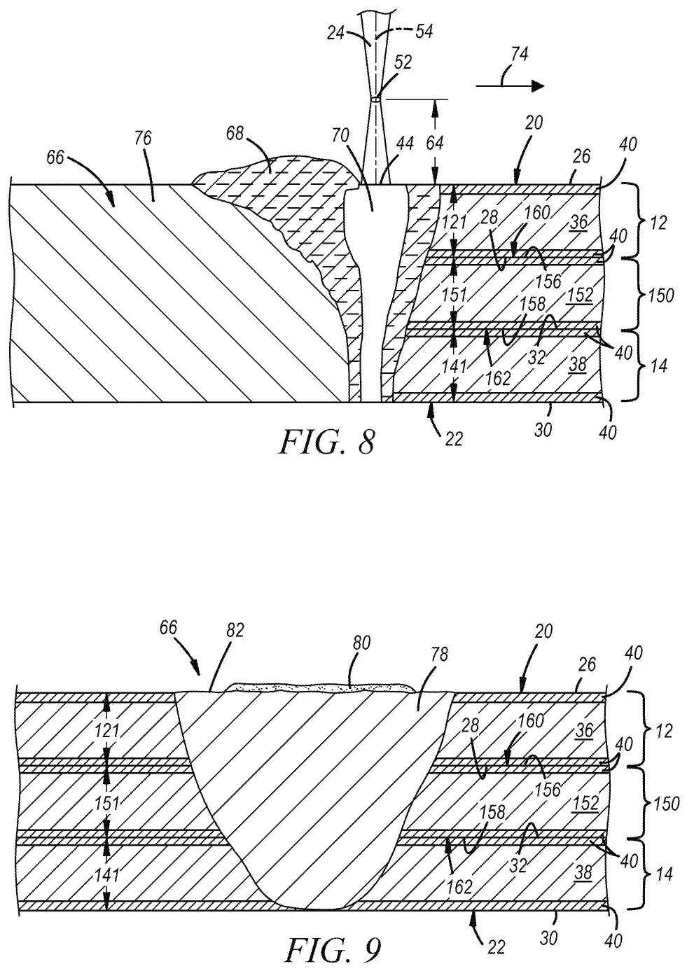

The disclosed method of laser welding together two or more light metal workpieces can be performed on a variety of workpiece stack-up configurations. For example, the disclosed method may be used in conjunction with a “2T” workpiece stack-up (FIGS. 1,3, and 5-7) that includes two overlapping light metal workpieces, or it may be used in conjunction with a “3T” workpiece stack-up (FIGS. 8-9) that includes three overlapping light metal workpieces. Still further, in some instances, the disclosed method may be used in conjunction with a “4T” workpiece stack-up (not shown) that includes four overlapping light metal workpieces. The two or more light metal workpieces included in the workpiece stack-up may all be aluminum workpieces or all magnesium workpieces, and they need not necessarily have the same composition (within the same base metal class) or have the same thickness as the others in the stack-up. The disclosed method is carried out in essentially the same way to achieve the same results regardless of whether the workpiece stack-up includes two overlapping light metal workpieces or more than two overlapping light metal workpieces. Any differences in workpiece stack-up configurations can be easily accommodated by adjusting the characteristics of the laser beams employed.

Referring now generally to FIG. 1, a workpiece stack-up 10 is shown in which the stack-up 10 includes at least a first light metal workpiece 12 and a second light metal workpiece 14 that overlap to define a welding region 16. A remote laser welding apparatus 18 that can perform the disclosed workpiece joining method is also shown. Within the confines of the welding region 16, the first and second light metal workpieces 12, 14 provide a top surface 20 and a bottom surface 22, respectively, of the workpiece stack-up 10. The top surface 20 of the workpiece stack-up 10 is made available to the remote laser welding apparatus 18 and is accessible by a laser beam 24 emanating from the remote laser welding apparatus 18. And since only single side access is needed to conduct laser welding, there is no need for the bottom surface 22 of the workpiece stack-up 10 to be made accessible in the same way. The terms “top surface” and “bottom surface” as used herein are relative designations that identify the surface of the stack-up 10 (top surface) that is more proximate to and facing the remote laser welding apparatus 18 and the surface of the stack-up 10 (bottom surface) that is facing in the opposite direction.

The workpiece stack-up 10 may include only the first and second light metal workpieces 12, 14, as shown in FIGS. 1, 3, and 5-7. Under these circumstances, and as shown best in FIG. 3, the first light metal workpiece 12 includes an exterior outer surface 26 and a first faying surface 28, and the second light metal workpiece 14 includes an exterior outer surface 30 and a second faying surface 32. The exterior outer surface 26 of the first light metal workpiece 12 provides the top surface 20 of the workpiece stack-up 10 and the exterior outer surface 30 of the second light metal workpiece 14 provides the oppositely-facing bottom surface 22 of the stack-up 10. And, since the two light metal workpieces 12, 14 are the only workpieces present in the workpiece stack-up 10, the first and second faying surfaces 28, 32 of the first and second light metal workpieces 12, 14 overlap and confront within the welding region 16 to establish a faying interface 34. In other embodiments, one of which is described below in connection with FIGS. 8-9, the workpiece stack-up 10 may include an additional third light metal metal workpiece disposed between the first and second light metal workpieces 12, 14 to provide the stack-up 10 with three light metal workpieces instead of two.

The term “faying interface” is used broadly in the present disclosure and is intended to encompass a wide range of overlapping relationships between the confronting first and second faying surfaces 28, 32 of the first and second light metal workpieces 12, 14 that can accommodate the practice of laser welding. For instance, the faying surfaces 28, 32 may establish the faying interface 34 by being in direct or indirect contact. The faying surfaces 28, 32 are in direct contact with each other when they physically abut and are not separated by a discrete intervening material layer or gaps that fall outside of normal assembly tolerance ranges. The faying surfaces 28, 32 are in indirect contact when they are separated by a discrete intervening material layer such as a sealer or adhesive—and thus do not experience the type of interfacial abutment that typifies direct contact—yet are in close enough proximity that laser welding can be practiced. As another example, the faying surfaces 28, 32 may establish the faying interface 34 by being separated by imposed gaps. Such gaps may be imposed between the faying surfaces 28, 32 by creating protruding features on one or both of the faying surfaces 28, 32 through laser scoring, mechanical dimpling, or otherwise. The protruding features maintain intermittent contact points between the faying surfaces 28, 32 that keep the surfaces 28, 32 spaced apart outside of and around the contact points by up to 1.0 mm.

Referring still to FIG. 3, the first light metal workpiece 12 includes a first light metal base layer 36 and the second light metal workpiece 14 includes a second light metal base layer 38. The first and second light metal base layers 36, 38 may all be composed of aluminum or magnesium; that is, the first and second light metal base layers 36, 38 are both composed of aluminum or both composed of magnesium. At least one of the first or second light metal base layers 36, 38, and usually both of the base layers 36, 38, includes a surface oxide coating 40. The surface oxide coating(s) 40 may be employed on one or both of the light metal base layers 36, 38 for various reasons including corrosion protection, strength enhancement, and/or to improve processing, among other reasons, and the composition of the surface oxide coating(s) 40 is based largely on the composition of the underlying light metal base layers 36, 38. Taking into the account the thickness of the light metal base layers 36, 38 and their surface oxide coatings 40, each of a thickness 121 of the first light metal workpiece 12 and a thickness 141 of the second light metal workpiece 14 preferably ranges from 0.4 mm to 6.0 mm at least within the welding region 16. The thicknesses 121, 141 of the first and second light metal workpieces 12, 14 may be the same or different from each other.

The light metal base layers 36, 38 may assume any of a wide variety of metal forms and compositions that fall within the broadly-recited base metal groups of aluminum and magnesium. For instance, if composed of aluminum, each of the light metal base layers 36, 38 (referred to for the moment as the first and second aluminum base layers 36, 38) may be separately composed of unalloyed aluminum or an aluminum alloy that includes at least 85 wt % aluminum. Some notable aluminum alloys that may constitute the first and/or second aluminum base layers 36, 38 are an aluminum-magnesium alloy, an aluminum-silicon alloy, an aluminum-magnesium-silicon alloy, or an aluminum-zinc alloy. Additionally, each of the aluminum base layers 36, 38 may be separately provided in wrought or cast form. For example, each of the aluminum base layers 36, 38 may be composed of a 4xxx, 5xxx, 6xxx, or 7xxx series wrought aluminum alloy sheet layer, extrusion, forging, or other worked article, or a 4xx.x, 5xx.x, or 7xx.x series aluminum alloy casting. Some more specific kinds of aluminum alloys that can be used as the first and/or second aluminum base layers 36, 38 include AA5182 and AA5754 aluminum-magnesium alloy, AA6011 and AA6022 aluminum-magnesium-silicon alloy, AA7003 and AA7055 aluminum-zinc alloy, and Al-10Si-Mg aluminum die casting alloy. The first and/or second aluminum base layers 36, 38 may be employed in a variety of tempers including annealed (O), strain hardened (H), and solution heat treated (T).

If the first and second light metal base layers 36, 38 are composed of magnesium, each of the light metal base layers 36, 38 (referred to for the moment as the first and second magnesium base layers 36, 38) may be separately composed of unalloyed magnesium or a magnesium alloy that includes at least 85 wt % magnesium. Some notable magnesium alloys that may constitute the first and/or second magnesium base layers 36, 38 are a magnesium-zinc alloy, a magnesium-aluminum alloy, a magnesium-aluminum-zinc alloy, a magnesium-aluminum-silicon alloy, and a magnesium-rare earth alloy. Additionally, each of the magnesium base layers 36, 38 may be separately provided in wrought (sheet, extrusion, forging, or other worked article) or cast form. A few specific examples of magnesium alloys that can be used as the first and/or second magnesium base layers 36, 38 include, but are not limited to, AZ91D die cast or wrought (extruded or sheet) magnesium alloy, AZ31B die cast or extruded (extruded or sheet) magnesium alloy, and AM60B die cast magnesium alloy. The first and/or second magnesium base layers 36, 38 may be employed in a variety of tempers including annealed (O), strain hardened (H), and solution heat treated (W).

The surface oxide coating 40 present on one or both of the light metal base layers 36, 38—regardless of whether the light metal base layers 36, 38 are composed of aluminum or magnesium—may be a native refractory oxide coating that forms passively when fresh metal of the base layer(s) 36, 38 is exposed to atmospheric air. This native refractory oxide coating may be comprised of aluminum oxide compounds or magnesium oxide compounds (and possibly magnesium hydroxide compounds) depending on whether the light metal base layers are composed of aluminum or magnesium. A thickness of the surface oxide coating 40 typically lies anywhere from 1 nm to 50 nm, although other thicknesses may be employed especially if additional processing techniques are practiced that seek to grow the surface oxide coating 40 such as anodization. Passively formed refractory oxide coatings, for example, often have thicknesses that range from 2 nm to 10 nm when the underlying light metal base layer is composed of aluminum or magnesium. Such surface oxide coatings 40 are mechanically tough and electrically and thermally insulating.

Referring back to FIG. 1, the remote laser welding apparatus 18 includes a scanning optic laser head 42. Generally speaking, the scanning optic laser head 42 directs the transmission of the laser beam 24 towards the top surface 20 of the workpiece stack-up 10 (also the exterior outer surface 26 of the first light metal workpiece 12). The directed laser beam 24 has a beam spot 44, which, as shown in FIG. 1A, is the sectional area of the laser beam 24 at a plane oriented along the top surface 20 of the stack-up 10. The scanning optic laser head 42 is preferably mounted to a robotic arm (not shown) that can quickly and accurately carry the laser head 42 to many different preselected sites within the welding region 16 in rapid programmed succession. The laser beam 24 used in conjunction with the scanning optic laser head 42 is preferably a solid-state laser beam operating with a wavelength in the near-infrared range (commonly considered to be 700 nm to 1400 nm) of the electromagnetic spectrum. Additionally, the laser beam 24 has a power level capability that can attain a power density sufficient to produce a keyhole, if desired, within the workpiece stack-up 10 during formation of the laser weld joint. The power density needed to produce a keyhole within the overlapping light metal workpieces 12, 14 is typically in the range of 0.5-1.5 MW/cm².

Some examples of a suitable solid-state laser beam that may be used in conjunction with the remote laser welding apparatus 18 include a fiber laser beam, a disk laser beam, and a direct diode laser beam. A preferred fiber laser beam is a diode-pumped laser beam in which the laser gain medium is an optical fiber doped with a rare earth element (e.g., erbium, ytterbium, neodymium, dysprosium, praseodymium, thulium, etc.). A preferred disk laser beam is a diode-pumped laser beam in which the gain medium is a thin laser crystal disk doped with a rare earth element (e.g., a ytterbium-doped yttrium-aluminum garnet (Yb:YAG) crystal coated with a reflective surface) and mounted to a heat sink. And a preferred direct diode laser beam is a combined laser beam (e.g., wavelength combined) derived from multiple diodes in which the gain medium is multiple semiconductors such as those based on aluminum gallium arsenide (AlGaAS) or indium gallium arsenide (InGaAS). Laser generators that can generate each of those types of lasers as well as other variations are commercially available. Other solid-state laser beams not specifically mentioned here may of course be used.

The scanning optic laser head 42 includes an arrangement of mirrors 46 that can maneuver the laser beam 24 and thus convey the beam spot 44 along the top surface 20 of the workpiece stack-up 10 within an operating envelope 48 that at least partially spans the welding region 16. Here, as illustrated in FIG. 1, the portion of the top surface 20 spanned by the operating envelope 48 is labeled the x-y plane since the position of the laser beam 24 within the plane is identified by the “x” and “y” coordinates of a three-dimensional coordinate system. In addition to the arrangement of mirrors 46, the scanning optic laser head 42 also includes a z-axis focal lens 50, which can move a focal point 52 (FIG. 1A) of the laser beam 24 along a longitudinal axis 54 of the laser beam 24 to thus vary the location of the focal point 52 in a z-direction oriented perpendicular to the x-y plane in the three-dimensional coordinate system established in FIG. 1. Furthermore, to keep dirt and debris from adversely affecting the optical system components and the integrity of the laser beam 24, a cover slide 56 may be situated below the scanning optic laser head 42. The cover slide 56 protects the arrangement of mirrors 46 and the z-axis focal lens 50 from the surrounding environment yet allows the laser beam 24 to pass out of the scanning optic laser head 42 without substantial disruption.

The arrangement of mirrors 46 and the z-axis focal lens 50 cooperate during operation of the remote laser welding apparatus 18 to dictate the desired movement of the laser beam 24 and its beam spot 44 within the operating envelope 48 as well as the position of the focal point 52 along the longitudinal axis 54 of the beam 24. The arrangement of mirrors 46, more specifically, includes a pair of tiltable scanning mirrors 58. Each of the tiltable scanning mirrors 58 is mounted on a galvanometer 60. The two tiltable scanning mirrors 58 can move the location of the beam spot 44—and thus change the point at which the laser beam 24 impinges the top surface 20 of the workpiece stack-up 10—anywhere in the x-y plane of the operating envelope 48 through precise coordinated tilting movements executed by the galvanometers 60. At the same time, the z-axis focal lens 50 controls the location of the focal point 52 of the laser beam 24 in order to help administer the laser beam 24 at the correct power density and to attain the desired heat input both instantaneously and over time. All of these optical components 50, 58 can be rapidly indexed in a matter of milliseconds or less to advance the beam spot 44 of the laser beam 24 relative to the x-y plane of the top surface 20 of the workpiece stack-up 10 along the closed-curved weld path(s) described more fully below while controlling the location of the focal point 52.

A characteristic that differentiates remote laser welding from other conventional forms of laser welding is the focal length of the laser beam 24. Here, as shown in best in FIG. 1, the laser beam 24 has a focal length 62, which is measured as the distance between the focal point 52 and the last tiltable scanning mirror 58 that intercepts and reflects the laser beam 24 prior to the laser beam 24 exiting the scanning optic laser head 42. The focal length 62 of the laser beam 24 is preferably in the range of 0.4 meters to 2.0 meters with a diameter of the focal point 52 typically ranging anywhere from 100 μm to 700 μm. The focal length, as well as a focal distance 64, can be easily adjusted. The term “focal distance” as used herein refers to the distance between the focal point 52 of the laser beam 24 and the top surface 20 of the workpiece stack-up 10 along the longitudinal axis 54 of the beam 24, as shown best in FIG. 1A. The focal distance 64 of the laser beam 24 is thus zero when the focal point 52 is positioned at the top surface 20 of the stack-up 10. Likewise, the focal distance is a positive distance value (+) when the focal point 52 is positioned above the top surface 20 and a negative distance value (−) when positioned below the top surface 20.

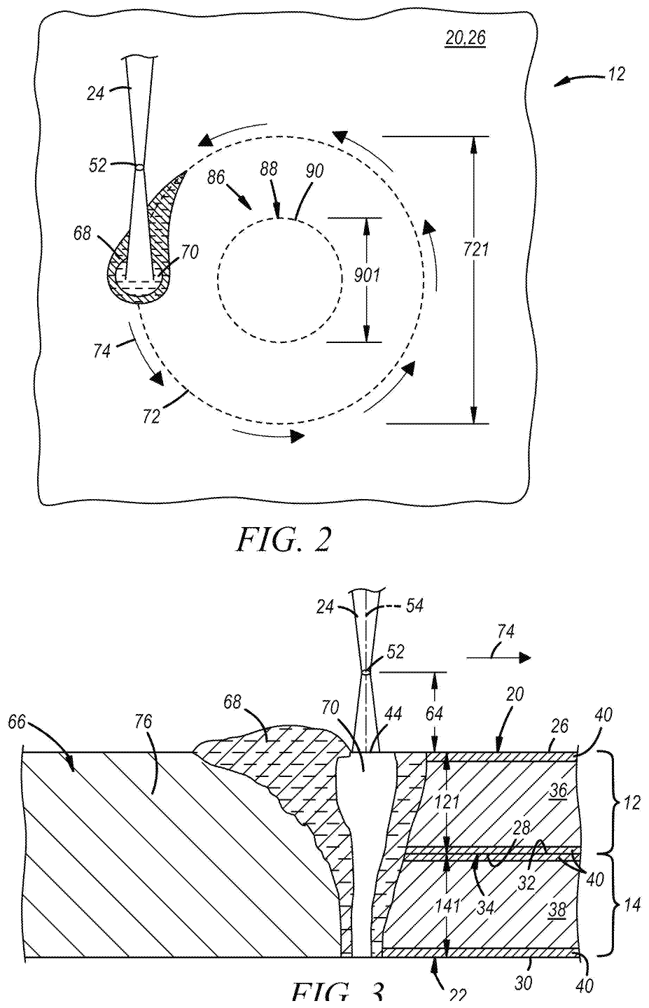

In the presently disclosed laser welding method, and referring now to FIGS. 1-7, a laser weld joint 66 is formed in the workpiece stack-up 10 by momentarily melting portions of the light metal workpieces 12, 14 with the laser beam 24 in a particular way. To form the laser weld joint 66, the laser beam 24 is directed by the scanning optic laser head 42 at top surface 20 of the workpiece stack-up at a predetermined weld site within the welding region 16. The resultant impingement of the top surface 20 of the stack-up 10 by the laser beam 24 creates a molten metal weld pool 68 within the stack-up 10, as shown in FIGS. 2-3, that penetrates into the stack-up 10 from the top surface 20 towards the bottom surface 22 and that may or may not initially intersect the faying interface 34 established between the first and second light metal workpieces 12, 14. Indeed, in the 2T stack-up shown in FIG. 3, the molten metal weld pool 68 may partially or fully penetrate the workpiece stack-up 10. A fully penetrating molten metal weld pool 68 penetrates entirely through the workpiece stack-up 10 and breaches the bottom surface 22 of the stack-up 10, as shown, while a partially penetrating molten metal weld pool 68 penetrates to some intermediate depth between the top and bottom surfaces 20, 22 and therefore does not extend to or breach the bottom surface 22 of the stack-up 10.

The laser beam 24, moreover, preferably has a power density sufficient to vaporize the workpiece stack-up 10 directly beneath the beam spot 44. This vaporizing action produces a keyhole 70, also depicted in FIGS. 2-5, which is a column of vaporized workpiece metal that oftentimes contains plasma. The keyhole 70 is formed within the molten metal weld pool 68 and exerts an outwardly-directed vapor pressure sufficient to prevent the surrounding molten metal weld pool 68 from collapsing inward. And, like the molten metal weld pool 68, the keyhole 70 also penetrates into the workpiece stack-up 10 from the top surface 20 towards the bottom surface 22 and may or may not initially intersect the faying interface 34 established between the first and second light metal workpieces 12, 14. The keyhole 70 provides a conduit for the first laser beam 24′ to deliver energy down into the workpiece stack-up 10, thus facilitating relatively deep and narrow penetration of the molten metal weld pool 68 into the workpiece stack-up 10. The keyhole 70 may fully (as shown) or partially penetrate the workpiece stack-up 10 along with the molten metal weld pool 68.

Upon creating the molten metal weld pool 68 and preferably the keyhole 70, the laser beam 24—and, in particular, its beam spot 44—is advanced multiple times along a closed-curved weld path 72, as illustrated in FIG. 2, in a forward direction 74 relative to the top surface 20 of the workpiece stack-up 10 in the x-y plane of the operating envelope 48. The closed-curved weld path 72 may be a circle weld path, as shown in FIG. 2, in which case a diameter 721 of the weld path is constant around its circumference. In another embodiment, however, the closed-curved weld path 72 can assume another geometrical shape in lieu of circle weld path including, for example, an elliptical weld path that has a major diameter that extends between the two farthest points on its circumference and a minor diameter that extends between the two closest points on its circumference. But regardless of its profile, the closed-curved weld path 72 is sized to correspond essentially to the desired circumference of the laser weld joint 66 as viewed from the top surface 20 of the workpiece stack-up 10; in other words, an area defined by the closed-curved weld path 72 is essentially equivalent to an area of the laser weld joint 66 that is ultimately formed. To that end, if the closed-curved weld path 72 is circular in form, its diameter 721 preferably ranges from 4 mm to 12 mm.

The laser beam 24 may be advanced multiple times along the closed-curved weld path 72 which, as previously indicated, corresponds essentially to the desired circumference of the laser weld joint 66 being formed. That is, the laser beam 24 is advanced more than once along the closed-curved weld path 72, meaning the laser beam 24 is effectively tracing the same weld path over and over again for a predetermined number of complete passes. The laser beam 24 may be advanced along the closed-curved weld path 72 at a beam travel speed of at least 8 m/min (meters per minute) and, more preferably, between 10 m/min and 50 m/min. The advancement of the laser beam 24 along the closed-curved weld path 72 at such a travel speed is managed by precisely controlling the coordinated movements of the tiltable scanning mirrors 58 within the scanning optic laser head 42 as described above. By repeatedly advancing the laser beam 24 along the closed-curved weld path 72 at this relatively high speed, which is appreciably faster than the beam travel speeds that are conventionally implemented during laser welding, i.e., 1 m/min to 5 m/min, the structural integrity of the laser weld joint 66 is believed to be positively affected, as will be further explained below.

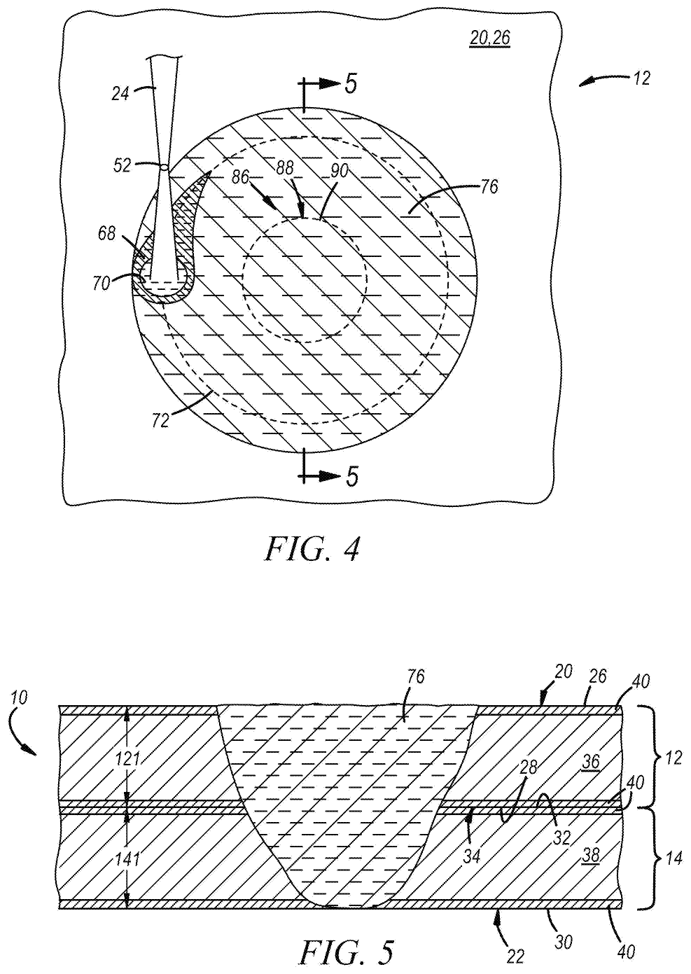

The repeated advancement of the beam spot 44 of the laser beam 24 along the closed-curved weld path 72 causes the molten metal weld pool 68 (along with the keyhole 70, if present) to be correspondingly translated along a similar route within the workpiece stack-up 10, as shown in FIG. 4. At the same time, the energy of the laser beam 24 that is absorbed by the workpiece stack-up 10 generates heat which, in turn, is transferred by conduction both radially inward from the closed-curved weld path 72 and downward towards the bottom surface 22 of the workpiece stack-up 10. As the laser beam 24 continues to trace the closed-curved weld path 72, this conductive heat transfer melts the portions of the first and second light metal workpieces 12, 14 inward and downward of the closed-curved weld path 72 to grow and develop a melt puddle 76 that eventually encompasses the entire area within the closed-curved weld path 72, as shown in FIGS. 4-5. The number of times the laser beam 24 needs to be advanced along the same closed-curved weld path 72 in order to develop the larger melt puddle 76 may vary depending on the compositions of the light metal workpieces 12, 14, the thicknesses 121, 141 of the workpieces 12, 14, and the desired size of the laser weld joint 66. In many instances, however, the laser beam 24 may be advanced completely along the closed-curved weld path 72 anywhere from four to eighty times or, more narrowly, from eight to thirty times.

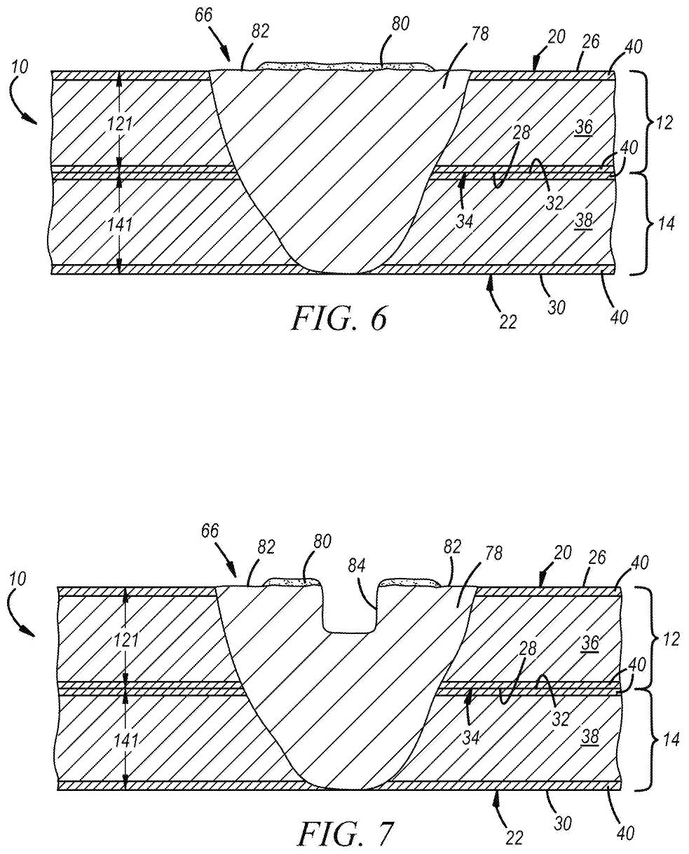

The melt puddle 76 is grown so that it intersects the faying interface 34 established between the two light metal workpieces 12, 14 while fully penetrating through the workpiece stack-up 10, as shown, or only partially penetrating through the stack-up 10. The inward growth of the melt puddle 76 and the stirring effect induced in the growing melt puddle 76 by the repeated and relatively fast advancement of the laser beam 24 along the closed-curved weld path 72 not only results in effective and efficient heat transfer into the workpiece stack-up 10, but those actions also cooperate to sweep or drive surface oxide coating fragments derived from the top surface 20, the faying interface 34, and possibly even the bottom surface 22 towards the center of the melt puddle 76. And, in addition to being swept or driven towards the center of the melt puddle 76, the ensnared surface oxide coating fragments have a tendency to rise to the top of the melt puddle 76, which is the exposed surface of the puddle 76 located nearest to the top surface 20 of the workpiece stack-up 10. Once the beam spot 44 of the laser beam 24 has finished repeatedly tracing the closed-curved weld path 72 on account of satisfactory growth and penetration of the melt puddle 76, the transmission of the laser beam 24 is halted or the laser beam 24 is otherwise removed from the closed-curved weld path 72. The resultant cessation of energy and heat transfer allows the melt puddle 76 to quickly cool and solidify into resolidified composite workpiece material 78, as shown in FIG. 6.

The collective resolidified composite workpiece material 78 obtained from the laser beam 24 constitutes the laser weld joint 66, which may extend fully through or partially into the workpiece stack-up 10, depending on whether the preceding melt puddle 76 fully or partially penetrated the stack-up 10, and may be surrounded by a heat-affected zone (HAZ). The laser weld joint 66 thus extends into the workpiece stack-up 10 from the top surface 20 of the stack-up 10 towards the bottom surface 22 while intersecting the faying interface 34 so as to autogenously fusion weld the light metal workpieces 12, 14 together. The composition of resolidified composite workpiece material 78 that comprises the laser weld joint 66 is determined by the compositions of the first and second light metal workpieces 12, 14. Moreover, as illustrated in representative fashion in FIG. 6 and not necessarily to scale, the surface oxide coating fragments that rose to the top of the melt puddle 76 during the repeated advancement of the laser beam 24 along the closed-curved weld path 72 may come to rest as film or other conglomeration 80 on a top surface 82 of the laser weld joint 66. The migration of those surface oxide coating fragments to the top surface 82 of the laser weld joint 66—and consequently out of the interior of the laser weld joint 66 where they might otherwise have stayed—significantly reduces and may even altogether eliminate porosity formation within the laser weld joint 66.

In some embodiments of the disclosed laser welding method, particularly when the diameter 721 of the closed-curve weld path is 72 is 6.5 mm or greater, a central notch 84 may materialize in the laser weld joint 66 that extends downwards from the top surface 82 of the joint 66, as shown in FIG. 7, as a result of the stirring effect induced by repeatedly advancing the laser beam 24 along the closed-curved weld path 72 and the rapid solidification of the melt puddle 76. The presence of a central notch 84 generally does not adversely affect the mechanical properties (e.g., tensile strength, cross-tension strength, etc.) of the laser weld joint 66. Rather, in most cases, the central notch 84 simply detracts from the cosmetic appearance of the laser weld joint 66 and can give the erroneous perception of a poor-quality weld joint. In those instances where a central notch 84 remains in the laser weld joint 66, the laser beam 24 may be retransmitted and its beam spot 44 advanced along a secondary beam travel pattern 86, which, as shown in FIG. 2, is projected onto the top surface 82 of the laser weld joint 66, after the laser beam 24 completes its repeated advancement along the closed-curved weld path 72. The advancement of the laser beam 24 along the secondary beam travel period 86 melts a central portion of the laser weld joint 66 and thus consumes the central notch 84 to thereby render the top surface 82 of the joint 66 more visually appealing.

The secondary beam travel pattern 86 is comprised of one or more weld paths 88 that span the central notch 84 and are located completely within the closed-curved weld path 72. The one or more weld paths 88 define an area that is preferably 50% or less than the area defined by the closed-curved weld path 72 and may assume any of a wide variety of geometric configurations. In one particular embodiment, for instance, the one or more weld paths 88 of the secondary beam travel pattern 86 may be a second closed-curved weld path 90 such as the circle weld path depicted in FIG. 2 or an elliptical weld path. Like before, the circle weld path that forms the secondary beam travel pattern 86 has a diameter 901 that is constant around its circumference. And, while the diameter 901 of the circle weld path of the secondary beam travel pattern 86 may vary depending on the size of the laser weld joint 66, in many instances the diameter 901 of the circle weld path preferably ranges from 0.5 mm to 6.0 mm. When a circle weld path is employed as the secondary weld pattern 86, as shown in FIG. 2, the laser beam 24 may be advanced multiple times along the weld path such as, for example, between two times and thirty times, at a beam travel speed that is preferably between 8 m/min and 120 m/min or, more narrowly, between 10 m/min and 60 m/min.

The secondary beam travel pattern 86 may assume other arrangements of the one or more weld paths 88 besides the second closed-curved weld path 90 (e.g., circle weld path or elliptical weld path) shown in FIG. 2. Indeed, the secondary beam travel pattern 86 may comprise a single spiral weld path, a series of concentric circular weld paths, a series of elliptical weld paths, an undulating weld path of spiral, circular, or elliptical shape, or a star or clover weld path, to name but a few examples. Specific implementations of some of these types of alternative arrangements of the one or more weld paths 88 are shown and described in PCT/CN2016/102669, PCT/CN2016/083112, PCT/CN2015/094003, PCT/CN2015/099569, and PCT/CN2015/088563. If any of these alternative arrangements of the one or more weld paths 88 are used as the secondary beam travel pattern 86, the weld path(s) 88 may cover a similarly-sized area on the top surface 82 of the laser weld joint 66 as the second closed-curved weld path 90 described above as having a preferred diameter 901 of 0.5 mm to 6.0 mm. The laser beam 24 may also be advanced one time or several times along any of the aforementioned alternative arrangements of one or more weld paths 88 at a beam travel speed that, preferably, is between 8 m/min and 120 m/min or, more narrowly, between 10 m/min and 60 m/min.

During practices of the disclosed laser welding method, as described above, the laser beam 24 is advanced multiple times along the closed-curved weld path 72, which produces the laser weld joint 66 with minimal if any porosity, and then may optionally be transitioned to and advanced along a secondary weld pattern 86 that is contained within the previously-traced closed-curved weld path 72 to eliminate the central notch 84 that is sometimes formed. The characteristics of the operating laser beam 24 needed to perform such a laser welding method in addition to the relatively fast beam travel speed as applicable to at least the closed-curved weld path 72 can be ascertained with ease by those skilled in the art. To be sure, the laser beam 24 may have a power level that ranges from 1 kW to 50 kW and a focal position between −30 mm and +30 mm (relative to the top surface 20 of the workpiece stack-up 10) during repeated advancement along the closed-curved weld path 72, and may further have a power level that ranges from 0.5 kW to 20 kW and a focal position between −50 mm and +50 mm during advancement along the secondary beam travel pattern 86 if the secondary beam travel pattern 86 forms part of the laser welding method.

FIGS. 1, 3, and 5-7 illustrate an embodiment of the workpiece stack-up 10 that includes two overlapping light metal workpieces 12, 14 establishing a single faying interface 34. Of course, as shown in FIGS. 8-9, the disclosed laser welding method may also be practiced on a workpiece stack-up 10 that includes an additional third light metal workpiece 150, with a thickness 151, situated between the first and second light metal workpieces 12, 14. The third light metal workpiece 150, if present, includes a third light metal base layer 152 that may also be coated with a surface oxide coating 40 (as shown). The third light metal workpiece 150 is similar in many general respects to the first and second light metal workpieces 12, 14 and, accordingly, the description of the first and second light metal workpieces 12, 14 set forth above (in particular the composition of the light metal base layers, their possible surface oxide coatings, and the workpiece thicknesses) applies fully to the third light metal workpiece 150. The welding region 16 in this embodiment of the workpiece stack-up 10 is now defined by the extent of the common overlap of all of the first, second, and third light metal workpieces 12, 14, 150.

As a result of stacking the first, second, and third light metal workpieces 12, 14, 150 in overlapping fashion to provide the workpiece stack-up 10, and as shown best in FIG. 8, the third light metal workpiece 40 has two faying surfaces: a third faying surface 156 and a fourth faying surface 158. The third faying surface 156 overlaps and confronts the first faying surface 28 of the first light metal workpiece 12 and the fourth faying surface 158 overlaps and confronts the second faying surface 32 of the second light metal workpiece 14. Within the welding region 16, the confronting first and third faying surfaces 28, 156 of the first and third light metal workpieces 12, 150 establish a first faying interface 160 and the confronting second and fourth faying surfaces 32, 158 of the second and third light metal workpieces 14, 150 establish a second faying interface 162. These faying interfaces 160, 162 are the same type and encompass the same attributes as the faying interface 34 described above with respect to the 2T stack-up shown in FIGS. 1, 3 and 5-7. Consequently, in this embodiment, the exterior outer surfaces 26, 30 of the flanking first and second light metal workpieces 12, 14 still face away from each other in opposite directions and constitute the top and bottom surfaces 20, 22 of the workpiece stack-up 10.

The disclosed laser welding method is practiced in the same general way as described above; that is, the laser beam 24 is advanced along the closed-curved weld path 72 multiple times, preferably making between four and eighty complete passes, at a beam travel speed of greater than 8 m/min or, more narrowly, between 10 m/min and 50 m/min, which causes the molten metal weld pool 68 and the keyhole 70 (if present) to be translated correspondingly within the stack-up 10, as depicted in FIGS. 2 and 7. The inward and downward conductive heat transfer associated with such advancement of the laser beam 24 along the closed-curved weld path 72 grows and develops the melt puddle 76 which, here, intersects each of the first and second faying interfaces 160, 162 established between the light metal workpieces 12, 14, 150 while fully penetrating through the workpiece stack-up 10, as shown, or only partially penetrating through the stack-up 10. The eventual halting of the transmission of the laser beam 24 causes the melt puddle 76 to cool and solidify into the resolidified composite workpiece material 78 that collectively constitutes the laser weld joint 66, as shown in FIG. 8. The laser beam 24 may then optionally be advanced along a secondary weld pattern 84 that is contained within the previously-traced closed-curved weld path 72 to eliminate the central notch 82 that may be formed depending on the size of the closed-curved weld path 72.

The above description of preferred exemplary embodiments and specific examples are merely descriptive in nature; they are not intended to limit the scope of the claims that follow. Each of the terms used in the appended claims should be given its ordinary and customary meaning unless specifically and unambiguously stated otherwise in the specification.

1. A method of laser welding together two or more light metal workpieces, the method comprising:
directing a laser beam at a top surface of a workpiece stack-up that comprises two or more overlapping light metal workpieces, the workpiece stack-up comprising at least a first light metal workpiece and a second light metal workpiece that overlap within a welding region, the first light metal workpiece providing the top surface of the workpiece stack-up and the second light metal workpiece providing a bottom surface of the workpiece stack-up, and wherein each pair of adjacent overlapping light metal workpieces within the workpiece stack-up establishes a faying interface therebetween;
advancing a beam spot of the laser beam relative to the top surface of the workpiece stack-up such that the beam spot is advanced multiple times along a closed-curved weld path at a beam travel speed of 8 m/min or greater to grow and develop a melt puddle that extends inwards and downwards from the closed-curved weld path on the top surface of the workpiece stack-up, the melt puddle penetrating the workpiece stack-up from the top surface of the workpiece stack-up towards the bottom surface and intersecting each faying interface established within the welding region of the workpiece stack-up,
allowing the melt puddle to solidify into a laser weld joint comprised of resolidified composite workpiece material, the laser weld joint fusion welding the two or more overlapping light metal workpieces together within the welding region.

2. The method set forth in claim 1, wherein the first light metal workpiece has an exterior outer surface and a first faying surface, and the second light metal workpiece has an exterior outer surface and a second faying surface, the exterior outer surface of the first light metal workpiece providing the top surface of the workpiece stack-up and the exterior outer surface of the second light metal workpiece providing the bottom surface of the workpiece stack-up, and wherein the first and second faying surfaces of the first and second light metal workpieces overlap and confront to establish a faying interface.

3. The method set forth in claim 1, wherein the first light metal workpiece has an exterior outer surface and a first faying surface, and the second light metal workpiece has an exterior outer surface and a second faying surface, the exterior outer surface of the first light metal workpiece providing the top surface of the workpiece stack-up and the exterior outer surface of the second light metal workpiece providing the bottom surface of the workpiece stack-up, and wherein the workpiece stack-up comprises a third light metal workpiece situated between the first and second light metal workpieces, the third light metal workpiece having opposed third and fourth faying surfaces, the third faying surface overlapping and confronting the first faying surface of the first light metal workpiece to establish a first faying interface and the fourth faying surface overlapping and confronting the second faying surface of the second light metal workpiece to establish a second faying interface.

4. The method set forth in claim 1, wherein each of the two or more overlapping light metal workpieces is an aluminum workpiece.

5. The method set forth in claim 1, wherein each of the two or more overlapping light metal workpieces is a magnesium workpiece.

6. The method set forth in claim 1, wherein the closed-curve weld path is a circle weld path.

7. The method set forth in claim 6, wherein the circle weld path has a diameter that ranges from 4 mm to 12 mm.

8. The method set forth in claim 1, wherein the beam spot of the laser beam is advanced completely along the closed-curve weld path anywhere from four times to eighty times.

9. The method set forth in claim 8, wherein the laser beam is advanced along the closed-curve weld path at a beam travel speed that ranges from 10 m/min to 50 m/min.

10. The method set forth in claim 1, wherein the laser beam is a solid-state laser beam, and wherein advancing the laser beam multiple times along the closed-curved weld path is performed by a remote laser welding apparatus.

11. The method set forth in claim 1, further comprising:
retransmitting the laser beam and advancing the beam spot of the laser beam relative to a top surface of the laser weld joint along a secondary beam travel pattern contained within the closed-curve weld path so as to melt a portion of the laser weld joint and to consume a central notch defined within the laser weld joint.

12. The method set forth in claim 11, wherein the secondary beam travel pattern comprises a second closed-curved weld path, and wherein the beam spot of the laser beam is advanced multiple times along the second closed-curved weld path at a beam travel speed of 8 m/min or greater.

13. The method set forth in claim 12, wherein the second closed-curved weld path is a second circle weld path, and a diameter of the second circle weld path ranges from 0.5 mm to 6.0 mm.

14. A method of laser welding together two or more light metal workpieces, the method comprising:
providing a workpiece stack-up that includes two or more light metal workpieces that overlap to define a welding region, the welding region of the workpiece stack-up having a top surface and a bottom surface and further establishing a faying interface between each pair of adjacent light metal workpieces included in the workpiece stack-up, and wherein all of the two or more light metal workpieces in the workpiece stack-up are aluminum workpieces or magnesium workpieces;
directing a laser beam at the top surface of the workpiece stack-up to create a keyhole and a molten metal weld pool that surrounds the keyhole, each of the keyhole and the surrounding molten metal weld pool penetrating into the workpiece stack-up from the top surface of the stack-up towards the bottom surface of the stack-up;
advancing a beam spot of the laser beam relative to the top surface of the workpiece stack-up such that the beam spot is advanced multiple times along a closed-curved weld path at a beam travel speed that ranges from 8 m/min to 120 m/min to grow and develop a melt puddle that extends inwards and downwards from the closed-curved weld path on the top surface of the workpiece stack-up, the melt puddle penetrating the workpiece stack-up from the top surface of the workpiece stack-up towards the bottom surface and intersecting each faying interface established within the welding region of the workpiece stack-up;
halting transmission of the laser beam to allow the melt puddle to solidify into a laser weld joint comprised of resolidified composite workpiece material, the laser weld joint fusion welding the two or more overlapping light metal workpieces together within the welding region, and wherein the laser weld joint further defines a central notch that extends downward into the laser weld joint from a top surface of the laser weld joint; and
retransmitting the laser beam and advancing the beam spot of the laser beam relative to the top surface of the laser weld joint along a secondary beam travel pattern contained within the closed-curve weld path so as to melt a portion of the laser weld joint and to consume the central notch.

15. The method set forth in claim 14, wherein the workpiece stack-up includes two or three overlapping light metal workpieces.

16. The method set forth in claim 14, wherein the closed-curved weld path is a circle weld path having a diameter that ranges from 4 mm to 12 mm.

17. The method set forth in claim 16, wherein the secondary beam travel pattern comprises a second circle weld path having a diameter that ranges from 0.5 mm to 6.0 mm, and wherein the beam spot of the laser beam is advanced multiple times along the second circle weld path.

18. A method of laser welding together two or three light metal workpieces, the method comprising:
providing a workpiece stack-up that includes two or three light metal workpieces that overlap to define a welding region, the welding region of the workpiece stack-up having a top surface and a bottom surface and further establishing a faying interface between each pair of adjacent light metal workpieces included in the workpiece stack-up, and wherein all of the two or more light metal workpieces in the workpiece stack-up are aluminum workpieces or magnesium workpieces;
forming a laser weld joint that fusion welds the two or three overlapping light metal workpieces together, wherein forming the laser weld joint comprises operating a scanning optic laser head of a remote laser welding apparatus to direct a laser beam at the top surface of the workpiece stack-up and, additionally, to advance a beam spot of the laser beam relative to the top surface of the workpiece stack-up such that the beam spot is advanced multiple times along a closed-curved weld path at a beam travel speed that ranges from 8 m/min to 120 m/min to grow and develop a melt puddle that extends inwards and downwards from the closed-curved weld path on the top surface of the workpiece stack-up.

19. The method set forth in claim 18, wherein the closed-curved weld path is a circle weld path having a diameter that ranges from 4 mm to 12 mm, and wherein the beam spot of the laser beam is advanced completely along the closed-curve weld path anywhere from four times to eighty times.

20. The method set forth in claim 18, further comprising:
advancing the beam spot of the laser beam relative to a top surface of the laser weld joint along a secondary beam travel pattern contained within the closed-curve weld path so as to melt a portion of the laser weld joint and to consume a central notch defined within the laser weld joint, and wherein the secondary beam travel pattern is comprised of one or more weld paths that define an area that is 50% or less than an area defined by the closed-curved weld path on the top surface of the workpiece stack-up.
